(19) United States
(12) Patent Application Publication
(10) Pub. No.: US 2009/0060469 A1
(43) Pub. Date: Mar. 5, 2009

(54) Systems and methods for recording popular media in an interactive media delivery system

(75) Inventors: Craig Alan Olague, Moorpark, CA (US); Kuan Hidalgo Archer, Los Angeles, CA (US); Henry C. Chilvers, Valencia, CA (US); Jeffrey Allan Fehervari, South Pasadena, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 11/897,960

(22) Filed: Aug. 31, 2007

(51) Int. Cl. H04N 7/26

(52) U.S. Cl. 386/124; 386/E05.001

(57) ABSTRACT

In many aspects, systems and methods for recording popular media among a subset of users of an interactive media delivery system using interactive media guidance applications are provided. The systems and methods for recording the popular media generally relate to determining and selecting for recording the popular media according to popularity criteria.

### BACKGROUND OF THE INVENTION

This invention relates generally to media systems, and more particularly, to systems and methods for recording popular media in an interactive media delivery system using interactive media guidance applications.

Video and audio media, such as television programs, pay-per-view (PPV) programs, near-video-on-demand (NVOD) programs, video-on-demand (VOD) programs, Internet-delivered video, digitally transmitted music, promotional material, or other types of media, are typically distributed to viewers over wired and wireless networks.

Viewers and listeners of such media typically record such media on videocassettes, audiocassettes, optical discs, hard-disk drives, and other storage media. Products have been developed that allow users to manage their viewing experiences and record media with unprecedented flexibility. Personal video recorders (PVRs), such as those provided by TIVO™, record programs on hard-disk drives or other digital storage devices. Users can schedule programs for recording and play them back at a later time. These systems also record what users are watching in real-time, allowing the users to pause real-time programs when, for example, the user must leave the room. Users may resume their viewing upon returning, where they left off, and may even fast forward through commercials until they reach the point at which the program is currently provided. Users may also rewind programs. User may also watch or listen to some media while simultaneously recording another.

Audience measurement techniques have long been used to provide information to system providers (e.g., television service companies) that desire information on the efficacy of their programming and advertisements. Due to the various ways user may access media, such as by recording it or playing it back, real-time access measurement techniques have been proposed for measuring user accesses and for providing information about the number of user accesses to users of recordable media. These real-time access measurement techniques are described in Berezowski et al. U.S. patent application Ser. No. 09/823,705, filed Mar. 30, 2001, which is hereby incorporated by reference herein in its entirety.

### SUMMARY OF THE INVENTION

In accordance with the principles of the present invention, systems and methods for recording popular media content using interactive media guidance applications are provided. The various embodiments described herein, generally speaking, record the most popular currently-available program, or currently-available programs meeting a popularity threshold. The capability to review an automatically recorded popular program or automatically recorded programs gives a user a sense of what others in the community are watching.

Recording is performed under the control of a suitable application, such as an interactive media guidance application running on a user's equipment. Alternatively, recording may be performed remotely on a server by, e.g., a guidance application server application. In such embodiments, the popular programs may be recorded in space associated with a user on the server, or may be recorded in shared space used by all users. In some embodiments, the user may access each recorded program separately. In other embodiments, the recorded programs may be watched contiguously, such as in a playlist.

Popularity may be determined based on any suitable criteria. For example, popularity may simply be based on the number of users currently watching a program. Alternatively, popularity may be based on the number of scheduled recordings, playbacks, or other accesses for a program. Changes in popularity may be detected on program boundaries. In such a case, entire programs are recorded. Alternatively, popularity may be continuously determined, resulting in portions of programs (i.e., “clips”) being recorded. As used herein, “program” or “programming” is intended to also refer to portions of programs. In some embodiments, a guidance application running on the user's equipment determines which program is the most popular or which programs meet a minimum popularity threshold, based on popularity information provided by a server. In other embodiments, a server remote to the user's equipment determines popularity and provides identifier data indicative of only the most popular program, or the programs meeting a minimum threshold.

To avoid filling up a user's storage device (e.g., personal video recorder), a set amount of storage space may be dedicated to the recording of popular currently-available programs. When the amount of space is used, earlier recorded programs may be over-written to record more recent and/or more popular programs. The amount of space may correspond to an amount of time, e.g., two hours of video. If desired, a time of day may be specified by programming logic or user inputs, to limit when the recordings occur (e.g., recording popular programs only from 6-8 PM).

Recordings may be limited by user-supplied or system defined criteria. For example, the media guidance application may receive user inputs defining, or based on monitored user behavior define, genres or other criteria and, in response, only record popular programs meeting the criteria. Popular recordings may be limited by user-supplied or system generated demographic criteria to limit recordings to those popular among a subset of users.

For purposes of clarity, and not by way of limitation, the systems and methods may sometimes be described herein in the context of recording video-based media content, such as television programs, VOD programs, or Internet-delivered video (referred to herein, at times, as simply “programs”). However, it may be understood that the systems and methods of the present invention may be applied to any other suitable type of media content, including audio-based media content, such as digitally transmitted music.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative displays that may be used to provide interactive media guidance application listings in accordance with one embodiment of the invention;

FIG. 3 shows an illustrative user equipment device in accordance with one embodiment of the invention;

FIG. 4 is a diagram of an illustrative cross-platform interactive media system in accordance with one embodiment of the invention;

FIG. 5 is a diagram of an illustrative system environment used to determine popular programs in accordance with one embodiment of the invention.

FIG. 6 shows an illustrative interactive media guidance application display that may be used to set options for recording popular programs in accordance with one embodiment of the invention;

FIG. 7 shows an illustrative display for turning the recording of popular programs on or off in accordance with one embodiment of the invention;

FIG. 8 shows an illustrative display for dedicating space on a storage device to recording popular programs in accordance with one embodiment of the invention;

FIG. 9 shows an illustrative display for setting a defined time period for which popular programs are determined and recorded in accordance with one embodiment of the invention;

FIG. 10 shows an illustrative display that may be used to set popularity criteria in accordance with one embodiment of the invention;

FIG. 11 shows an illustrative display that may be used to select a subset of users of the interactive media delivery system in accordance with one embodiment of the invention;

FIG. 12 shows an illustrative display that may be used to exclude from selection for recording programs that are inconsistent with user preferences in accordance with one embodiment of the invention;

FIG. 13 shows an illustrative display that may be used to display information such as listing of recorded programs, popularity level of a recorded program, and statistics on users of the recorded programs within the selected user segment, in accordance with one embodiment of the invention;

FIGS. 14-19 are illustrative process flowcharts of steps involved in recording popular programs according to various embodiments of the invention.

### DETAILED DESCRIPTION OF THE PREFERRED EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

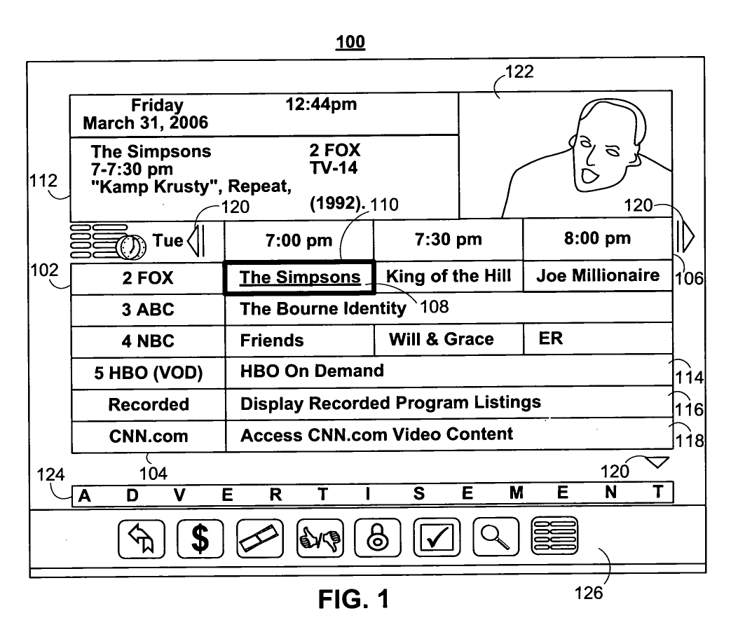

One of the functions of the media guidance application is to provide media listings and media information to users along with allowing users to record and watch saved programs. FIGS. 1-2 and 6-13 show illustrative displays that may be used to provide media guidance, and in particular media listings and recording options. The displays shown in FIGS. 1-2 and 6-13 may be implemented on any suitable device or platform. While the displays of FIGS. 1-2 and 6-13 are illustrated as full-screen displays, they may also be fully or partially overlaid over media content being displayed. A user may indicate a desire to access media information by selecting a selectable option provided in a display (e.g., a menu option, a listings option, an icon, a hyperlink, etc.) or pressing a dedicated button (e.g., a GUIDE button) on a remote control or other user input interface or device. In response to the user's indication, the media guidance application may provide a display with media information organized in one of several ways, such as by time and channel in a grid, by time, by channel, by media type, by category (e.g., movies, sports, news, children, or other categories of programming), recording priority, recording order, or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. Other information and indicators may also be included in grid cells. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information such as whether the program is being recorded, whether there is a scheduling conflict, or any other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP). Non-linear programming content may also include digital images and text based information, digital music and other audio content.

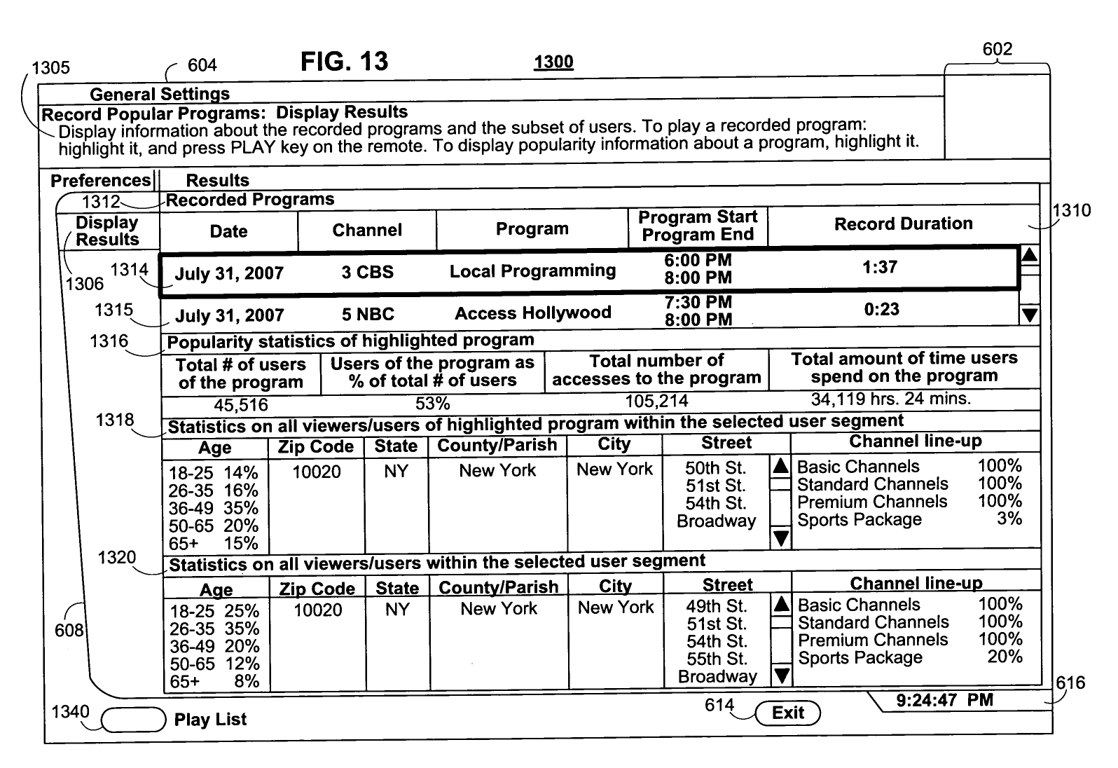

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display listing recorded popular programs such as the display illustrated in FIG. 13, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application displays of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user behavior, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application displays of the present invention.

Options region 126 may allow the user to access different types of media content, media guidance application displays, and/or media guidance application features. Options region 126 may be part of display 100 (and other displays of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, modifying a recording priority of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user behavior to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, recorded popular programs, user-specified broadcast channels based on favorite channel selections, re-ordering the display of channels, recommended media content, etc.), desired recording features (e.g., recording or series recordings for particular users, recording popular programs, recording quality, recording priority of programs, recording and cropping options etc.), parental control settings, and other desired customizations.

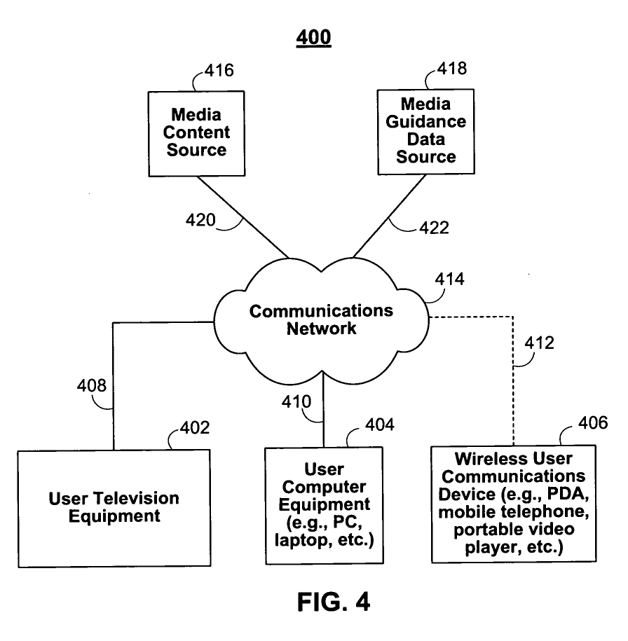

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

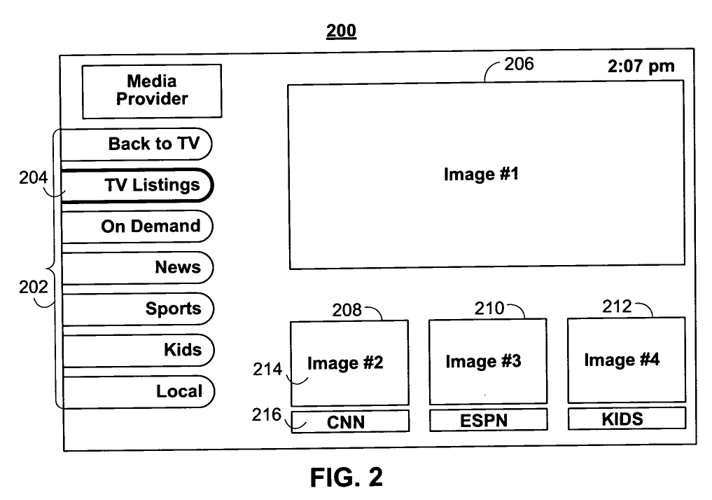

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

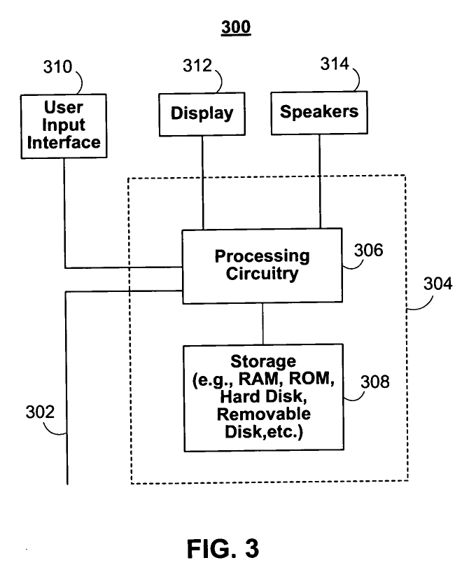

Users may access media content and the media guidance application (and its displays described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to dedicate space on and direct recording of information to storage devices (e.g., storage 308), and direct displaying of information on display devices (e.g. display 312). Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server, remote recording server, or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, popularity information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG (e.g., MPEG-2, MPEG-4) decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning, encoding and decoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PCs, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user behavior monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Popular programs may be recorded on the remote media server in space associated with a user or in shared space used by all users. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, popularity information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data, popularity information, and other guidance data may be provided to the user equipment on a television channel sideband, in the vertical blanking interval of a television channel, using an in-band digital signal, using an out-of-band digital signal, or by any other suitable data transmission technique. Program schedule data, popularity information, and other guidance data may be provided to user equipment on multiple analog or digital television channels. Program schedule data, popularity information, and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 (FIG. 3) of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, are discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 402 and user computer equipment 404 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

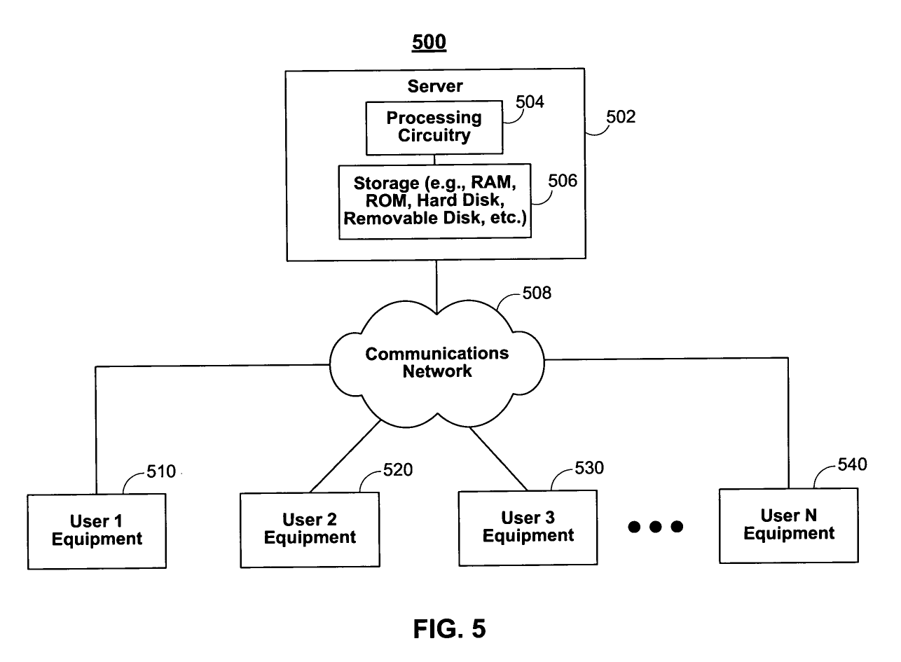

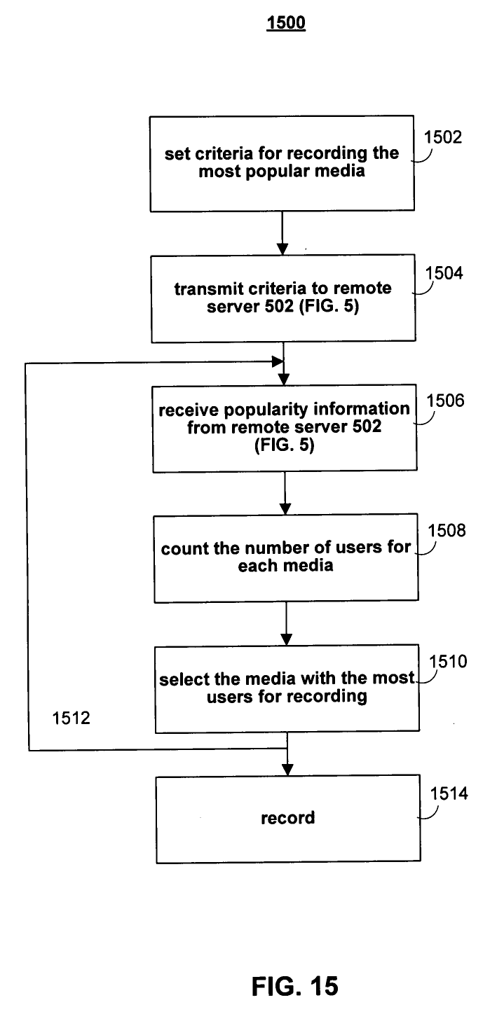

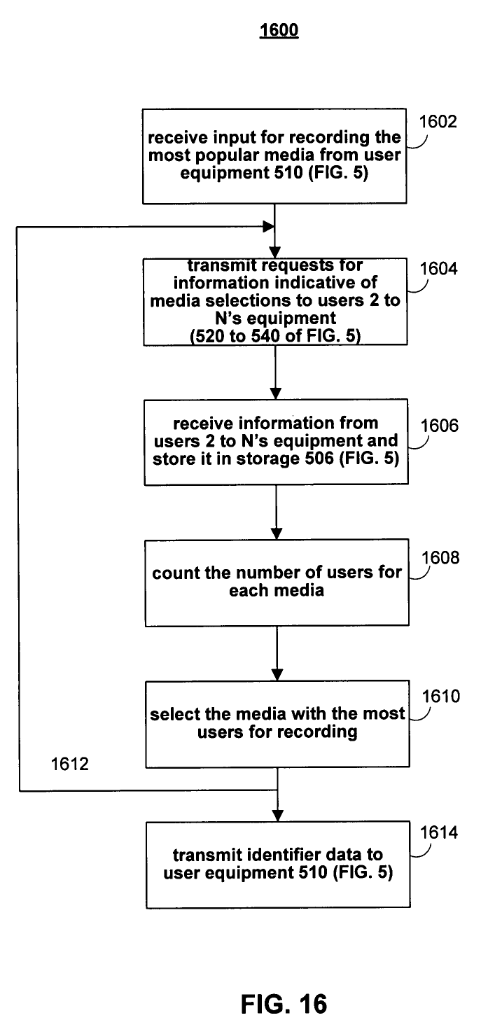

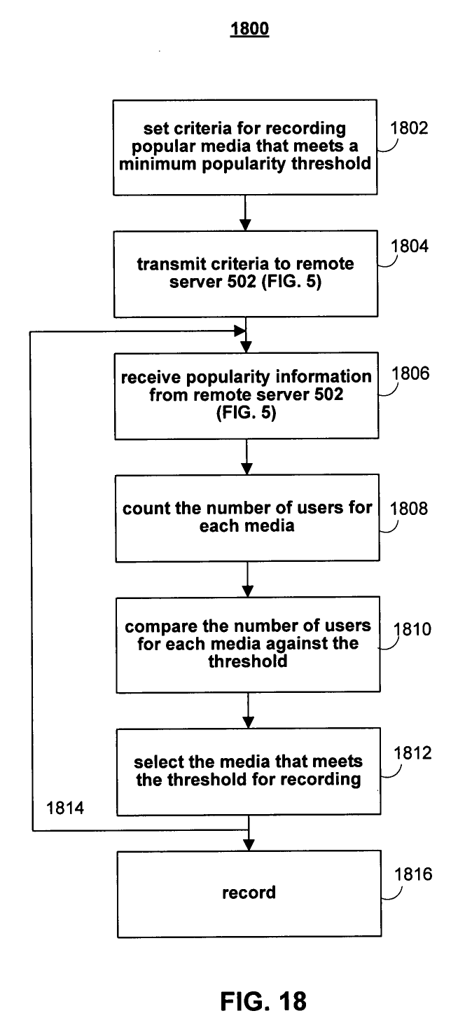

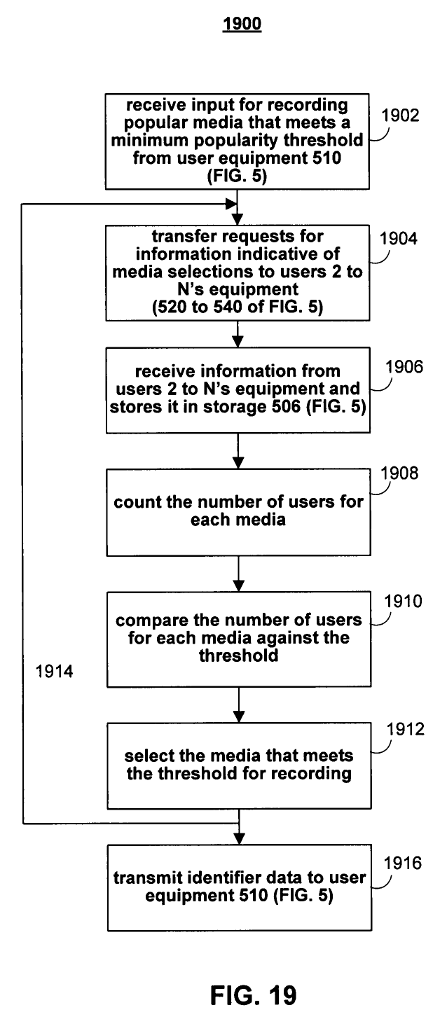

FIG. 5 shows a diagram of a system that may be used to determine popular programs in accordance with one embodiment of the invention. In particular, FIG. 5 shows equipment of users of an interactive media delivery system connected to remote server 502 via communications network 508. Control circuitry of remote server 502 includes processing circuitry 504 and storage 506. Control circuitry of remote server 502 may be used to send and receive commands, requests, and other suitable data, dedicate space on and direct recording of information to storage devices, and direct displaying of information on display devices. Control circuitry of remote server 502 may be based on any suitable processing circuitry 504 such as processing circuitry based on one or more microprocessors, microcontrollers, digital signal processors, programmable logic devices, etc. In some embodiments, control circuitry of remote server 502 executes instructions for a media guidance application stored in memory (i.e., storage 506). User equipment may include user television equipment 402 (FIG. 4), user computer equipment 404 (FIG. 4), or wireless user communications device 406 (FIG. 4). User equipment is described in connection with FIG. 3. Remote server 502 may be part of media guidance data source 418 (FIG. 4). It receives data indicative of users' program selections from users' equipment (e.g., user equipment 510 to 540 of FIG. 5) connected to it via communications network 508 (FIG. 5). Based on the data, a determination of popular programs is made. For example, user equipment 510 may obtain input via user input interface 310 (FIG. 3) from user 1 to record popular programs among users 2 to N. User equipment 510 transmits user input to remote server 502 (FIG. 5). In one embodiment, remote server 502 processes the data indicative of users 2 to N's program selections to generate identifier data indicative of popular media and transmits the identifier data to user equipment 510 (e.g., described in connection with FIGS. 16, 19). In another embodiment, user equipment 510 receives from remote server 502 popularity information such as data indicative of users 2 to N's program selections and processes the information to generate identifier data indicative of popular media (e.g., described in connection with FIGS. 15, 18). Popularity information may also be provided by a third party that tracks user activity (e.g., Nielsen). Popular programs among users 2 to N may also be determined by sampling a subset of users (e.g., a statistical sampling indicative of users 3 to N−1's program selections) and then extrapolating from the sample. Any suitable sampling and extrapolation algorithms/techniques may be used. The sampling/extrapolation may be performed, for example, by remote server 502 control circuitry under the control of the instructions of a guidance application server application or a third party (e.g., Nielsen).

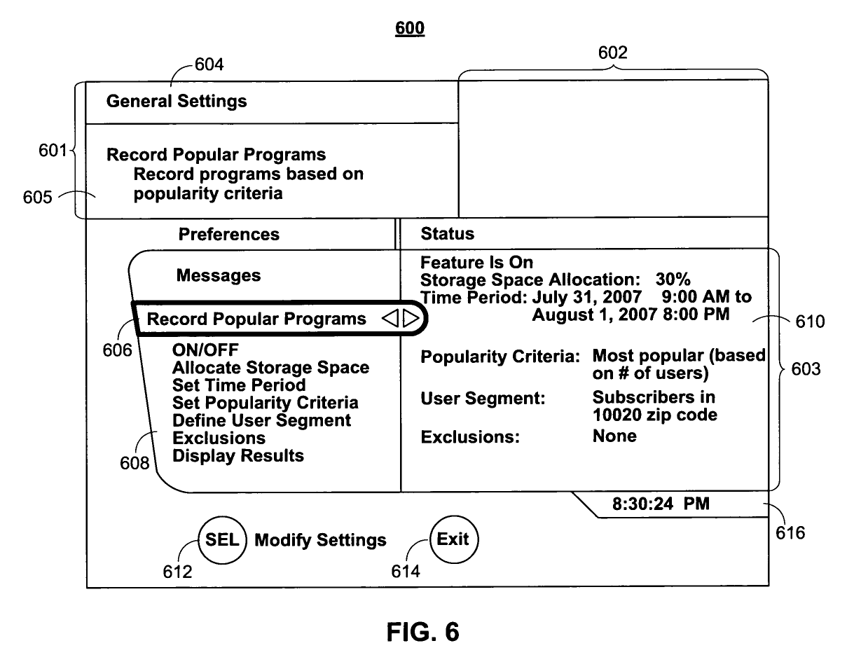

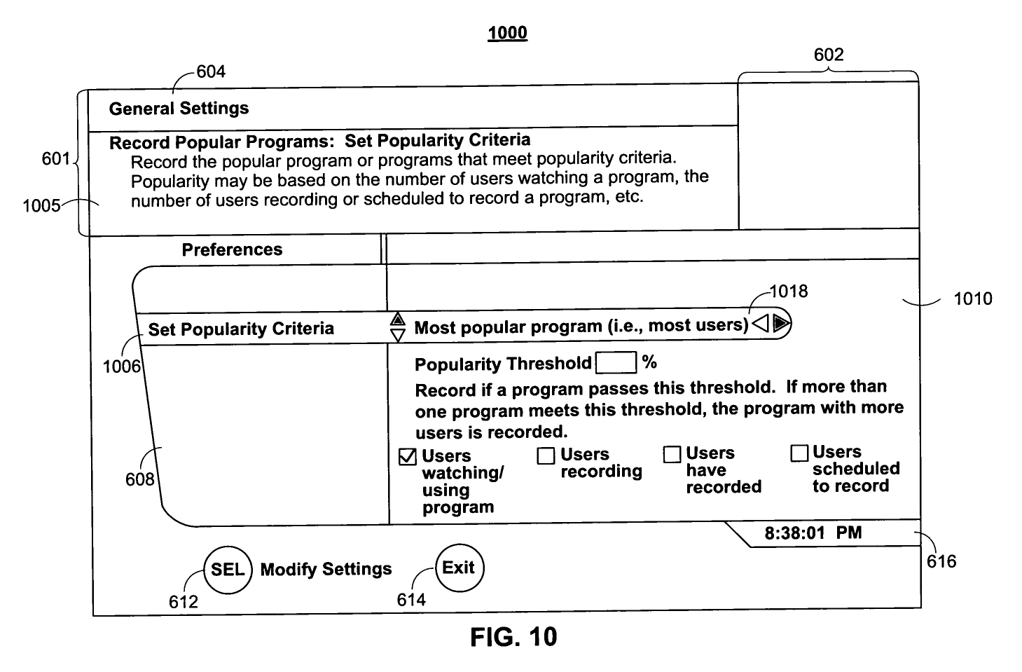

FIG. 6 shows an illustrative interactive media guidance application display that may be used to set options for recording popular programs that may be displayed on display 312 (FIG. 3) of user equipment device or media device 402, 404 or 406 (FIG. 4). Options may be set based on, for example, user input or system-generated input such as a user guide data feed, and appropriate warning messages may be displayed if any setting is inappropriate. In particular, FIG. 6 shows an illustrative interactive media guidance application display 600 that includes header region 601 with header identifier region 604 and description region 605, options selection region 603, and video region 602 (sometimes referred to as a “picture-in-guide” or “PIG” region) that may be used to display videos, messages, or other information. Display regions in the interactive media guidance application can utilize scrolling to display additional information. Box 616 displays the current time. In the example of FIG. 6, header region 601 shows the function category that the interactive media guidance application is currently in (“General Settings”). Options selection region 603 includes options region 608 and details region 610. Options region 608 displays available options under a function category and displays available sub-options under an option when the option is highlighted. Details region 610 displays status of an option when the option is highlighted in 608 and displays details of an option when the option is selected in 608. Description region 605 displays a description of a highlighted option. If options for recording popular programs are set based on user input, a user may input information through user input interface 310 (FIG. 3). Highlighting an option in 608 may be accomplished, for example, by navigating through user input interface 310 (FIG. 3) until the desired option is highlighted on display 312 (FIG. 3). Selecting an option in 608 may be accomplished, for example, by pressing a select button (indicated by 612) on user input interface 310 (FIG. 3) when the desired option is highlighted. In the example of FIG. 6, option “Record Popular Programs” 606 under function category “General settings” is highlighted in options region 608. Accordingly, options region 608 displays available sub-options under “Record Popular Programs,” details region 610 displays the status of the sub-options, and description region 605 displays a description for the “Record Popular Programs” option. Exiting display 600 may be accomplished, for example, by pressing an exit button (indicated by 614) on user input interface 310. Any other suitable options may be included in options region 608. For example, “Pop-Up Alerts” may be included as a sub-option under “Record Popular Programs” and listed below “Display Results” in region 608. When “Pop-Up Alerts” is on, it will pop up a display, for example, to alert a current viewer/user that another program on another channel just met certain popularity criteria and provide the viewer/user with options to tune to that channel or to record that program. For example, “Pop-Up Alerts” may be set to display a pop-up alert if 20% of current viewers in the 91030 zip code are watching a comedy show. The popularity criteria for “Pop-Up Alerts” may be set using a display similar to the “Set Popularity Criteria” display (the “Set Popularity Criteria” display is discussed in connection with FIG. 10).

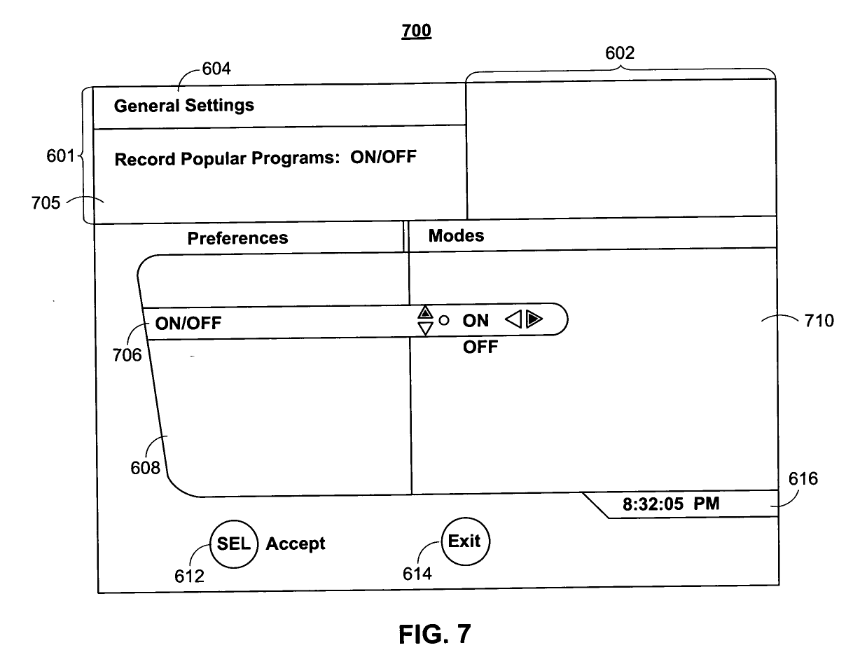

FIG. 7 shows an illustrative interactive media guidance application display that may be used to turn the recording of popular programs option on or off. This display may be displayed on display 312 (FIG. 3) of user equipment device or media device 402, 404 or 406 (FIG. 4). In particular, FIG. 7 shows an illustrative interactive media guidance application display 700 that is displayed after the “On/Off” sub-option of “Record Popular Programs” is highlighted and selected in FIG. 6. Description region 705 shows a description of the selected option. Options region 608 shows the selected option 706. Details region 710 shows settings (“ON” or “OFF”) for the selected option. Turning on the “Record Popular Programs” option, for example, may be accomplished by pressing a select button (indicated by 612) on user input interface 310 (FIG. 3). In the example of FIG. 7, turning off the “Record Popular Programs” option may be accomplished by navigating through user input interface 310 (FIG. 3) until the desired setting (“OFF”) is highlighted on display 700 and then selecting the setting by pressing a select button (indicated by 612) on user input interface 310 (FIG. 3).

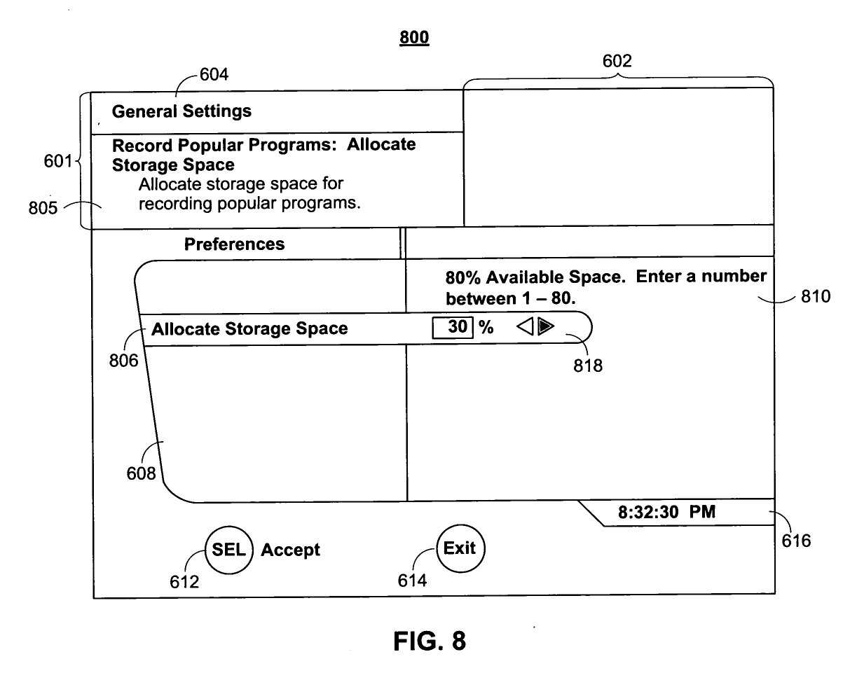

FIG. 8 shows an illustrative interactive media guidance application display that may be used to dedicate space on a storage device to recording popular programs. The storage device maybe 308 (FIG. 3) within a user's equipment, 506 (FIG. 5) within a server remote from a user's equipment, or any internal or external storage device based on any number of storage media, including optical drives, hard disk drives, and flash memory. This display may be displayed on display 312 (FIG. 3) of user equipment device or media device 402, 404 or 406 (FIG. 4). In particular, FIG. 8 shows an illustrative interactive media guidance application display 800 that is displayed after the “Allocate Storage Space” sub-option of “Record Popular Programs” is highlighted and selected in FIG. 6. Description region 805 shows a description of the selected option. Options region 608 shows the selected option 806. Details region 810 shows available settings for the selected option. In the example of FIG. 8, details region 810 indicates that 80% of the total storage capacity of the storage device is available for recording popular programs and asks a user to enter a number between 1-80, representing 1% to 80% of the storage device's total capacity. If the “Allocate Storage Space” option is set based on user input, a user may input information through user input interface 310 (FIG. 3). Dedicating 30% of total storage capacity to recording popular programs, for example, may be accomplished by highlighting available setting 818 using the navigational features of user input interface 310 (FIG. 3), entering the digits ‘3’ ‘0’ using user input interface 310 (FIG. 3), and pressing a select button (indicated by 612) on user input interface 310 (FIG. 3). Amount of storage allocated may be represented by ways other than a percentage of the storage device's total capacity. For example, amount of storage allocated may be represented by physical size (e.g., 2 GB or 500 MB), recording length (e.g., two hours), or using any other suitable approach. If an inappropriate allocation (e.g., desired space is greater than available space) is entered, the interactive media guidance application may display an appropriate warning message on display 312 (FIG. 3). Although the discussion of FIG. 8 refers to the options as set by a user, the system (e.g., the interactive media guidance application, user equipment device 300 (FIG. 3) or remote server 502 (FIG. 5)) may automatically set options by dedicating an appropriate amount of space for recording based on available space in the storage device. The storage device with the dedicated space may be within a user's equipment (e.g., storage 308 of FIG. 3) or within a server remote from a user's equipment (e.g., storage 506 of FIG. 5). Dedicated space in 506 may be associated with the user or in shared space used by all users. Recording popular media may write over earlier-recorded media when the dedicated space has been filled.

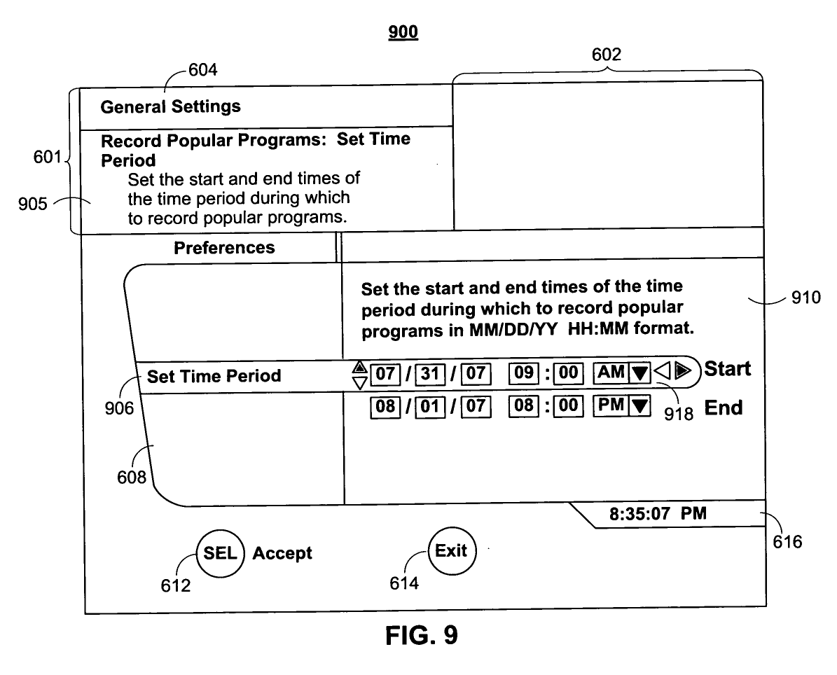

FIG. 9 shows an illustrative interactive media guidance application display that may be used to set start and end times of a defined time period for which popular programs are determined and recorded. This display may be displayed on display 312 (FIG. 3) of user equipment device or media device 402, 404 or 406 (FIG. 4). In particular, FIG. 9 shows an illustrative interactive media guidance application display 900 that is displayed after the “Set Time Period” sub-option of “Record Popular Programs” is highlighted and selected in FIG. 6. Description region 905 shows a description of the selected option. Options region 608 shows the selected option 906. Details region 910 shows available settings for the selected option. Setting the start time, for example, may be accomplished by highlighting available setting 918 using the navigational features of user input interface 310 (FIG. 3) and entering the desired date and time in the appropriate fields using user input interface 310 (FIG. 3). Setting the end time follows a similar procedure. Pressing a select button (indicated by 612) on user input interface 310 (FIG. 3) accepts the settings just entered. Other ways to define the time period may be presented by the interactive media guidance application, such as every time user television is off or continuous as long as “Record Popular Programs” option is on. In the example of FIG. 9, Details region 910 shows that start time is set to be 9:00 AM on Jul. 31, 2007 and the end time is set to be 8:00 PM on Aug. 1, 2007. If an inappropriate time period (e.g., end time occurs earlier than start time) is entered, the interactive media guidance application may display an appropriate warning message on display 312 (FIG. 3). The “Set Time Period” option may allow other suitable features, such as detecting changes in popularity on program boundaries (e.g., once recording of a popular program starts, the program is recorded in its entirety before determination of popularity begins again) instead of determining popularity continuously. Although the discussion of FIG. 9 refers to the options as set by a user, the system may automatically set an appropriate, defined time period as well (e.g., one week, every time user television is off, or continuous for as long as the “Record Popular Programs” option is on).

FIG. 10 shows an illustrative interactive media guidance application display that may be used to set popularity criteria used to determine popular programs. This display may be displayed on display 312 (FIG. 3) of user equipment device or media device 402, 404 or 406 (FIG. 4). In particular, FIG. 10 shows an illustrative interactive media guidance application display 1000 that is displayed after the “Set Popularity Criteria” sub-option of “Record Popular Programs” is highlighted and selected in FIG. 6. Description region 1005 shows a description of the selected option. Options region 608 shows the selected option 1006. Details region 1010 shows available settings for the selected option. In the example of FIG. 10, the popularity of a program may be determined based on the number of users of the interactive media delivery system watching/using the program, recording/having recorded/having scheduled to record the program, or all of the above. Taking into account the number of users who have scheduled to record a program provides an advance indication of program popularity and allows determination of popular programs before they are shown, so recording can start at the beginning of the programs. The “Set Popularity Criteria” option may allow popularity to be determined based on additional suitable criteria (e.g., only popular programs from certain genres). Setting the popularity criteria as the most popular program (e.g., most users) based on number of users watching/using the program, for example, may be accomplished by highlighting available setting 1018 using the navigational features of user input interface 310 (FIG. 3), checking the appropriate box for users watching/using a program using user input interface 310 (FIG. 3), and pressing a select button (indicated by 612) on user input interface 310 (FIG. 3). User equipment 300 (FIG. 3) or remote server 502 (FIG. 5) may determine the most popular program (described in connection with FIGS. 15-16). In another embodiment, a user may set a popularity threshold as the popularity criteria. For example, a program is determined to be popular if the number of users watching/using the program meets or exceeds 50% of current users of the interactive media delivery system, or if the number of users watching/using the program exceeds 100,000. In the example of FIG. 10, details region 1010 shows a popularity threshold setting in terms of percentages. In cases where more than one program simultaneously meets a popularity threshold (for example, a program with 40% popularity, a program with 30% popularity, and a program with 25% popularity, with the popularity threshold set at 25%), the ability to simultaneously record these programs may be limited by the number of tuners in user equipment 300 (FIG. 3) or other constraints. In such a case, the most popular programs are selected for recording (for example, the program with 40% popularity is recorded if user equipment 300 (FIG. 3) has one tuner available for recording). User equipment 300 (FIG. 3) or remote server 502 (FIG. 5) may determine the popular program based on popularity threshold (described in connection with FIGS. 18-19). Although the discussion of FIG. 10 refers to the options as set by a user, the system may automatically set options (e.g., based on monitored user behavior, etc.). For example, if monitored user behavior indicates that user likes the situation comedy genre, the system may set options such that only popular situation comedies are recorded.

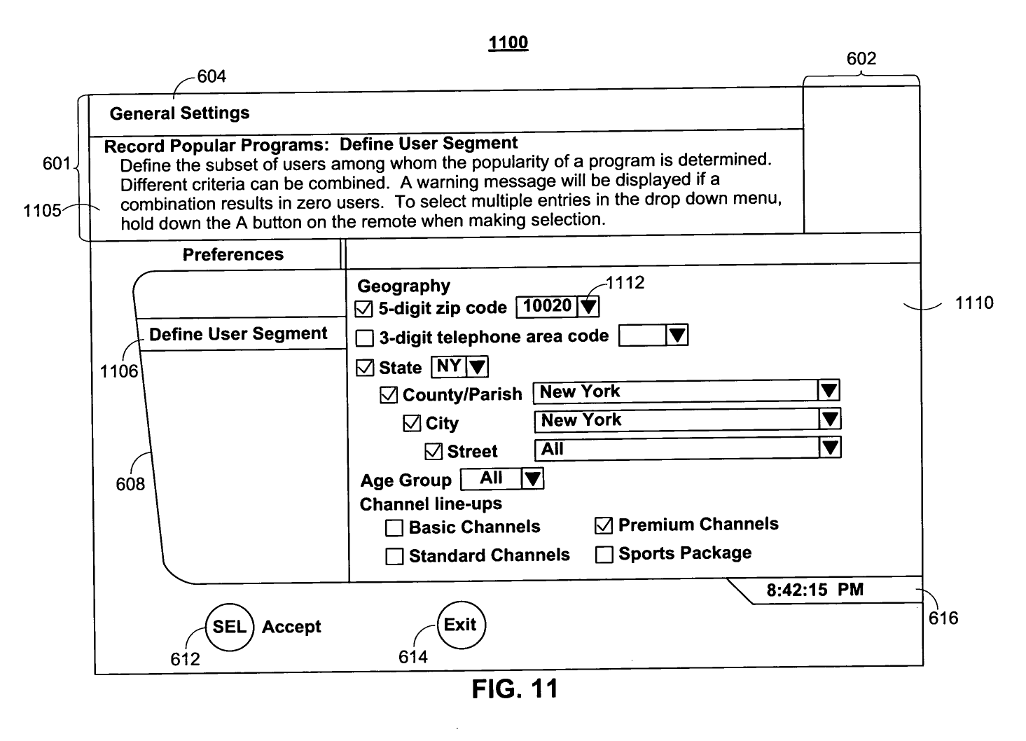

FIG. 11 shows an illustrative interactive media guidance application display that may be used to define a subset of users of the interactive media delivery system among whom the popularity of a program is determined. This display may be displayed on display 312 (FIG. 3) of user equipment device or media device 402, 404 or 406 (FIG. 4). In particular, FIG. 11 shows an illustrative interactive media guidance application display 1100 that is displayed after the “Define User Segment” sub-option of “Record Popular Programs” is highlighted and selected in FIG. 6. Description region 1105 shows a description of the selected option. Options region 608 shows the selected option 1106. Details region 1110 shows available settings for the selected option. In the example of FIG. 11, choosing all users of the interactive media delivery system who live in the 10020 zip code (among whom popularity of a program is determined) may be accomplished by highlighting available setting “5-digit zip code” using the navigational features of user input interface 310 (FIG. 3), checking the box next to “5-digit zip code” and entering the “10020” zip code using user input interface 310 (FIG. 3). The “10020” zip code may also be selected from the drop down box 1112. Selecting other criteria, such as demographic criteria, follows a similar procedure, and different criteria can be combined. The selected criteria in details region 1110 shows all users in both the 10020 zip code and New York City of all ages and subscribing to the premium channels line-up. Pressing a select button (indicated by 612) on user input interface 310 (FIG. 3) accepts these settings. Other suitable criteria, such as user gender, user income level, or primary language used at home, may be used if such information is available. Although the discussion of FIG. 11 refers to the options as set by a user, the system may automatically set options (e.g., based on monitored user behavior, etc.). For example, if a user lives in the 10020 zip code, the system may select all users in the 10020 zip code.

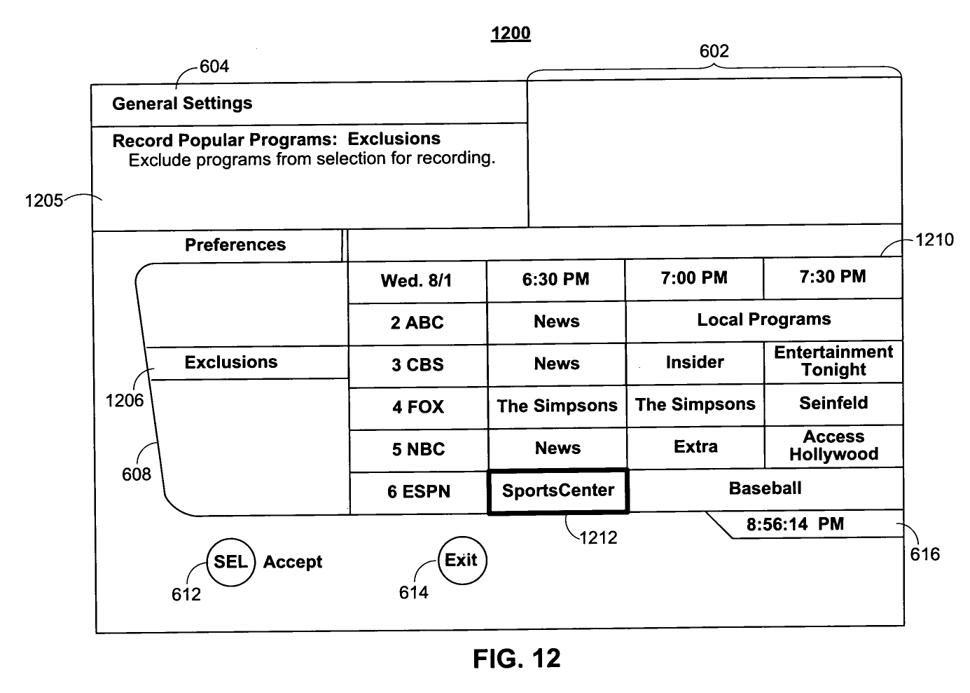

FIG. 12 shows an illustrative interactive media guidance application display that may be used to exclude programs from selection for recording. For example, a user who does not like sports may exclude the Super Bowl, a program likely to be popular by most popularity criteria, from selection for recording. This exclusions display may be displayed on display 312 (FIG. 3) of user equipment device or media device 402, 404 or 406 (FIG. 4). Processing circuitry (e.g., under the control of the instructions of an interactive media application) in user equipment or in a remote server maybe configured to exclude programs from selection for recording.

In particular, FIG. 12 shows an illustrative interactive media guidance application display 1200 that is displayed after the “Exclusions” sub-option of “Record Popular Programs” is highlighted and selected in FIG. 6. Description region 1205 shows a description of the selected option. Options region 608 shows the selected option 1206. Details region 1210 shows available settings for the selected option. The size, shape, layout and contents of the cells in details region 1210 may be similar to those of the grid 102 in FIG. 1. Region 1210 includes cells of program listings, such as program listing 1212 for “SportsCenter.” SPORTSCENTER is a trademark owned by ESPN. A user who does not like sports may exclude SportsCenter from selection for recording by highlighting 1212 using the navigational features of user input interface 310 (FIG. 3) and pressing a select button (indicated by 612) on user input interface 310 (FIG. 3) to accept this setting. Additional programs may be excluded using a similar procedure. The “Exclusions” option may allow programs to be excluded based on additional suitable criteria (e.g., no programs from certain genres, etc.). Although the discussion of FIG. 12 refers to the options as set by a user, the system may automatically set options (e.g., based on monitored user behavior, etc.). For example, if monitored user behavior indicates that user does not like the soap opera genre, the system may set options to exclude all soap operas as indicated by a user guide data feed.

FIG. 13 shows an illustrative interactive media guidance application display that may be used to display information about the recorded programs and the selected subset of users of the interactive media delivery system and to play the recorded programs. This display may be displayed on display 312 (FIG. 3) of user equipment device or media device 402, 404 or 406 (FIG. 4). In particular, FIG. 13 shows an illustrative interactive media guidance application display 1300 that is displayed after the “Display Results” sub-option of “Record Popular Programs” is highlighted and selected in FIG. 6. Description region 1305 shows a description of the selected option. Options region 608 shows the selected option 1306. Details region 1310 shows the information provided by the selected option and reflects the results of settings shown in FIGS. 8-12. Additional information, if available, may be displayed as well (e.g. popularity of the recorded programs among all users of the interactive media delivery system). The information may be displayed in any suitable format. For example, details region 1310 may simply show a listing of recorded programs only. A user may highlight a program from the listing using the navigational features of user input interface 310 of FIG. 3 (e.g., a remote control) and press an info button to get a separate display with information related to the highlighted program and its users.

In the example of FIG. 13, the “Recorded Programs” display region 1312 lists programs recorded according to the popularity criteria set. Two programs are shown in 1312 and additional recorded programs can be shown by using the scroll bar on the right. Programs that are currently being recorded may also be displayed, and indicators may be used to show that recording is in progress and options to view those programs live may be provided. Highlighting a program using the navigational features of user input interface 310 (FIG. 3) displays information such as popularity statistics of the highlighted program (1316), statistics on viewers/users of the highlighted program within the selected subset of users (1318), and statistics (e.g., demographic, neighborhood) on the selected subset of users (1320). Other information, such as other user demographic information, may be displayed as well. Information on users such as demographics may be voluntarily provided by the users when they subscribe to the interactive media delivery system and stored in remote server storage 506 (FIG. 5). Popularity statistics may be obtained when determination of popular programs are made. For example, when remote server 502 is making the determination of the most popular program among users 2 to N upon user 1's request, it receives data indicative of users 2 to N's media selections from users 2 to N's equipment (user equipment 520 to 540 of FIG. 5). Based on this information, server processing circuitry 504 (FIG. 5) can count the number of users using a particular program. Remote server 502 may also keep track of the total number of times a user accesses a particular program or the total time a user spends on a program by communicating with the user's equipment via communications network 508 (FIG. 5). Remote server 502 (FIG. 5) aggregates these individual pieces of data to obtain popularity statistics on a program.

In the example of FIG. 13, the first program (1314) was shown on channel 3 from 6:00 PM to 8:00 PM on Jul. 31, 2007. One hour 37 minutes of the program was recorded (i.e., the program met the popularity criteria for one hour 37 minutes). The second program (1315) was shown on channel 5 from 7:30 PM to 8:00 PM on Jul. 31, 2007 and therefore overlapped with the last thirty minutes of the first program. Twenty-three minutes of program two was recorded (i.e., the program met the popularity criteria for 23 minutes). After program two started at 7:30 PM, it gained viewers/users and became more popular than program one, so recording started on program two and stopped on program one, leaving out the last 23 minutes of program one. The information provided by 1300 can give a user a sense of what others in the community are watching and help the user catch the programs that the neighbors are watching the most. To play a recorded program, user may press a play button on a remote control that is part of user input interface 310 (FIG. 3) when the program is highlighted in 1310. To play all recorded programs, user may select “Play List” button 1340 (FIG. 13).

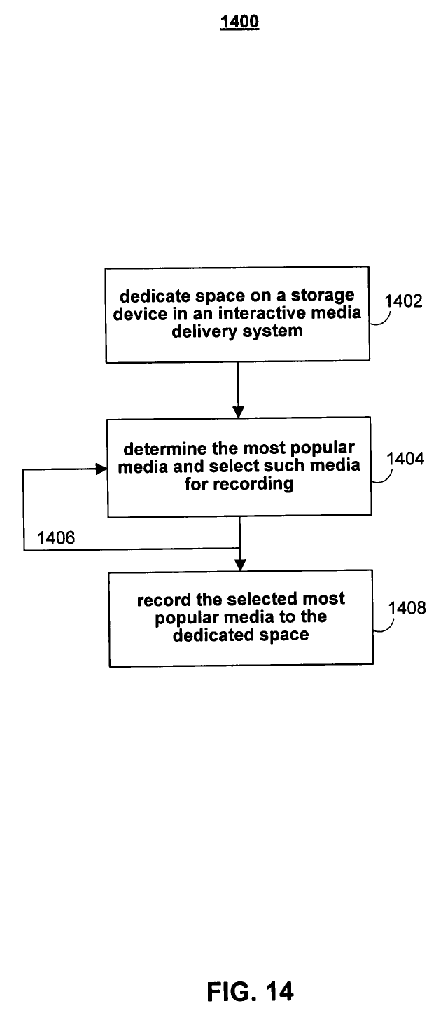

FIGS. 14-19 are illustrative process flow charts of steps involved in determining and recording popular media. The steps in FIGS. 14-19 may be carried out by or under the direction of remote server 502 (FIG. 5) control circuitry or user equipment 300 (FIG. 3) control circuitry. In particular, FIG. 14 depicts a process 1400 which determines and records the most popular media among at least a subset of users of an interactive media delivery system. Process 1400 may take place in an environment depicted in FIG. 5. Step 1402 dedicates space on a storage device to recording the most popular media among a subset of users of the interactive media delivery system. The space may be dedicated by user equipment processing circuitry 306 (FIG. 3) or remote server processing circuitry 504 (FIG. 5) and may be located on user equipment storage 308 (FIG. 3) or remote server storage 506 (FIG. 5). Dedicated space in 506 may be associated with the user. Step 1404 determines the most popular media within the interactive media delivery system and selects the most popular media for recording during a defined period of time. Depending on the media delivery technology used, selecting the media for recording may involve tuning to an analog channel or decoding a digital signal via, for example, communications network 414 (FIG. 4). Step 1406 shows that if different media becomes the most popular during the defined period of time the different media is selected. Step 1408 records at least a portion of the selected most popular media to the dedicated space. Steps 1402, 1404, 1406, and 1408 may be carried out by remote server 502 (FIG. 5) or user equipment 300 (FIG. 3).

FIG. 15 depicts a process of determining the most popular media undertaken at user equipment 510 (FIG. 5). In step 1502, user equipment 510 (FIG. 5) sets criteria for recording the most popular media among a subset of users of the interactive media delivery system (e.g., users 2 to N). Setting criteria for recording popular media is explained earlier. Control circuitry 304 (FIG. 3) obtains the recording criteria and dedicates space on either user equipment storage 308 (FIG. 3) or remote server storage 506 (FIG. 5). User equipment 510 (FIG. 5) transmits the criteria to remote server 502 via communications network 508 (FIG. 5) (step 1504). Remote server 502 receives the input and processing circuitry 504 interprets the input (FIG. 5). Processing circuitry 504 transmits requests for information indicative of media selections to users 2 to N's equipment (520 to 540) via communications network 508, and receives this information from users 2 to N's equipment via 508 (FIG. 5). Depending on the criteria set for the “Set Popularity Criteria” option (described in connection with FIG. 10), the information may include, for example, the media users 2 to N are currently watching or using, the media users 2 to N are currently recording, the media users 2 to N have scheduled to record, or combinations thereof. Remote server 502 may process this popularity information before transmitting it to user equipment 510 via communications network 508 (FIG. 5). User equipment 510 receives the information (step 1506) and stores it in storage 308 (FIG. 3). Using this information, user equipment 510 processing circuitry 306 (e.g., under the control of the instructions of an interactive media guidance application) determines the most popular media by, for example, counting the number of users for each media (step 1508) and selecting the media with the most users for recording (step 1510). User equipment 510 commences recording after the selection is made (step 1514). Step 1512 shows that the process keeps looking for the most popular media, which may change over time.

FIG. 16 depicts an embodiment where a process of determining the most popular media is undertaken at remote server 502 (FIG. 5). In step 1602, remote server 502 receives from user equipment 510 via communications network 508 input for recording the most popular media among a subset of users of the interactive media delivery system (e.g., users 2 to N) (FIG. 5). Remote server 502 transmits requests for information indicative of media selections to users 2 to N's equipment (520 to 540) via communications network 508 (step 1604), receives this information from users 2 to N's equipment (520 to 540) via 508 and stores it in 506 (step 1606) (FIG. 5). Depending on the criteria set for the “Set Popularity Criteria” option (described in connection with FIG. 10), the information may include, for example, the media users 2 to N are currently watching or using, the media users 2 to N are currently recording, the media users 2 to N have scheduled to record, or combinations thereof. Remote server 502 processes this information to generate identifier data indicative of the most popular media. Remote server processing circuitry 504 (e.g., under the control of the instructions of a guidance application server application) generates the identifier data, for example, by counting the number of users for each media (step 1608) and selecting the media used by the most users for recording (step 1610). Remote server 502 transmits the identifier data to user equipment 510 via communications network 508 (FIG. 5) (step 1614). User equipment 510 commences recording after receipt of the identifier data. Step 1612 shows that the process keeps looking for the most popular media, which may change over time.

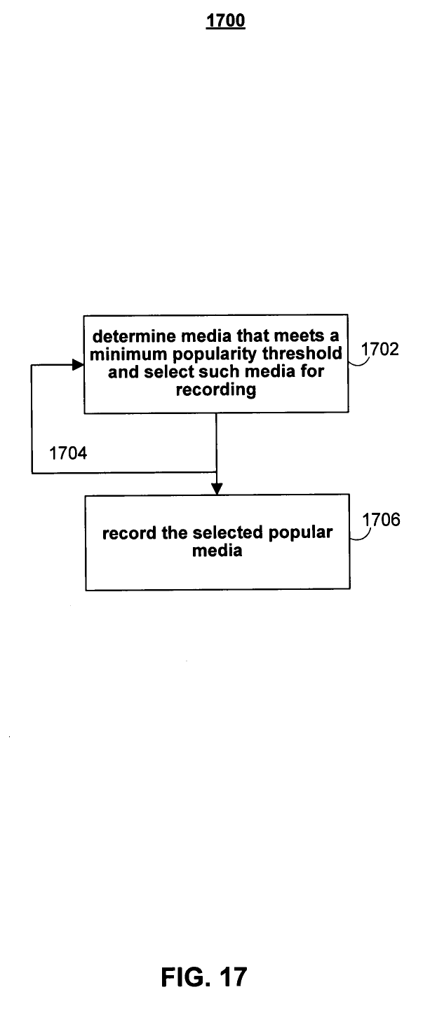

FIG. 17 depicts a process 1700 which determines and records popular media that meets a minimum popularity threshold among at least a subset of users of an interactive media delivery system. Process 1700 may take place in an environment depicted in FIG. 5. Step 1702 determines media that meets a minimum popularity threshold among at least a subset of users of an interactive media delivery system and selects such media for recording. Depending on the media delivery technology used, selecting the media for recording may involve tuning to an analog channel or decoding a digital signal. Step 1704 shows that if different media meets the threshold the different media is selected. Step 1706 records at least a portion of the selected popular media. Steps 1702, 1704, and 1706 may be carried out by remote server 502 (FIG. 5) or user equipment 300 (FIG. 3).

FIG. 18 depicts a process of determining popular media that meets a minimum popularity threshold undertaken at user equipment 510 (FIG. 5). In Step 1802, user equipment 510 (FIG. 5) sets criteria for recording popular media that meets a minimum popularity threshold among a subset of users of the interactive media delivery system (e.g., users 2 to N). User equipment 510 (FIG. 5) transmits the criteria to remote server 502 via communications network 508 (FIG. 5) (step 1804). Remote server 502 receives the input and processing circuitry 504 interprets the input (FIG. 5). Processing circuitry 504 transmits requests for information indicative of media selections to users 2 to N's equipment (520 to 540) via communications network 508, and receives this information from users 2 to N's equipment (520 to 540) via 508 (FIG. 5). Depending on the criteria set for the “Set Popularity Criteria” option (described in connection with FIG. 10), the information may include, for example, the media users 2 to N are currently watching or using, the media users 2 to N are currently recording, the media users 2 to N have scheduled to record, or combinations thereof. User equipment 510 receives the information (step 1806) and stores it in 308 (FIG. 3). Using this information, user equipment 510 processing circuitry 306 (e.g., under the control of the instructions of an interactive media guidance application) determines the media that meets a minimum popularity threshold. For example, if the minimum popularity threshold is 50% of all current users of the interactive media delivery system and there are 100,000 users currently using the system, then user equipment 510 counts the number of users for each media (step 1808), compares the number of users for each media against the threshold (50,000 users) (step 1810), and selects the media that has at least 50,000 users for recording (step 1812). User equipment 510 commences recording after the selection is made (1816). Step 1814 shows that the process keeps looking for a popular media that meets the minimum threshold, which may change over time.

FIG. 19 depicts an embodiment where a process of determining popular media that meets a minimum popularity threshold is undertaken at remote server 502 (FIG. 5). In Step 1902, remote server 502 (FIG. 5) receives from user equipment 510 (FIG. 5) via communications network 508 (FIG. 5) input for recording popular media that meets a minimum popularity threshold among a subset of users of the interactive media delivery system (e.g., users 2 to N). Remote server 502 (FIG. 5) receives the recording request and processing circuitry 504 (FIG. 5) interprets it. Processing circuitry 504 transmits requests for information indicative of media selections to users 2 to N's equipment (520 to 540) via communications network 508 (step 1904), receives this information from users 2 to N's equipment (520 to 540) via 508 and stores it in 506 (step 1906) (FIG. 5). Depending on the criteria set for the “Set Popularity Criteria” option (described in connection with FIG. 10), the information may include, for example, the media users 2 to N are currently watching or using, the media users 2 to N are currently recording, the media users 2 to N have scheduled to record, or combinations thereof. Remote server 502 processes this information to generate identifier data indicative of the popular media. Remote server processing circuitry 504 (e.g., under the control of the instructions of a guidance application server application) generates the identifier data. For example, if the minimum popularity threshold is 50% of all current users of the interactive media delivery system and there are 100,000 users currently using the system, identifier data is generated by counting the number of users for each media (step 1908), comparing the number of users for each media against the threshold (step 1910), and selecting the media used by at least 50,000 users for recording (step 1912). Remote server 502 transmits the identifier data to user equipment 510 via communications network 508 (FIG. 5) (step 1916). User equipment 510 commences recording after receipt of the identifier data. Step 1914 shows that the process keeps looking for popular media that meets the minimum threshold, which may change over time.

The order in which the steps of the present method are performed is purely illustrative in nature. In fact, the steps can be performed in any order or in parallel, unless otherwise indicated by the present disclosure. The invention may be embodied in other specific forms without departing from the spirit or essential characteristics thereof. The foregoing embodiments are each therefore to be considered in all respects illustrative, rather than limiting of the invention.

1. A method for recording popular media to a storage device in an interactive media delivery system, comprising:
determining media that meets a minimum popularity threshold among at least a subset of users of the interactive media delivery system and selecting such media for recording, wherein as different media meets the threshold the different media is selected; and
recording at least a portion of the selected popular media.

2. The method defined in claim 1 further comprising:
selecting for recording the most popular media if more than one media meet the threshold at a given time.

3. The method defined in claim 1 wherein the popularity threshold comprises a number indicating a percentage of users in the interactive media delivery system that is watching or using media for the media to be selected for recording.

4. The method defined in claim 1 wherein the popularity threshold comprises a number indicating a percentage of users in the interactive media delivery system that is recording or have scheduled to record media for the media to be selected for recording.

5. The method defined in claim 1 wherein determining the media that meets a minimum popularity threshold is performed by a server remote from a user's equipment, comprising:
receiving from equipment of the subset of users data indicative of the users' media selections;
processing the data to generate identifier data indicative of the popular media; and
transmitting the identifier data to said user's equipment.

6. The method defined in claim 5, wherein the user's equipment commences recording upon receipt of the identifier data from the server.

7. The method defined in claim 1 wherein determining the media that meets a minimum popularity threshold comprises:
receiving from a remote server popularity information; and
processing the popularity information to generate identifier data indicative of the popular media.

8. The method defined in claim 1 further comprising excluding from selection for recording the popular media that are inconsistent with user preferences.

9. The method defined in claim 1 wherein the media is a television program, a video-on-demand (VOD) video, an Internet-delivered video, or digitally transmitted music.

10. The method defined in claim 1 wherein the storage device is within a user's equipment.

11. The method defined in claim 1 wherein the storage device is within a server remote from a user's equipment.

12. The method defined in claim 1 further comprising dedicating space on the storage device to record the selected popular media, wherein recording at least a portion of the selected popular media comprises writing over earlier-recorded media when the dedicated space has been filled.

13. The method defined in claim 1 wherein selecting the media for recording comprises tuning to an analog channel or decoding a digital signal.

14. The method defined in claim 1 wherein:
determining the popular media comprises:
determining the popular media among a subset of users within the interactive media delivery system that meets the threshold;
selecting the popular media among the subset of users; and
recording at least a portion of the selected popular media comprises recording the selected popular media for the subset of users.

15. The method defined in claim 1 wherein the subset of users is defined according to user demographic, by zip code, geographical area, similar channel line-ups, city, county or state.

16. The method defined in claim 15, further comprising displaying demographic or neighborhood information on the subset of users.

17. The method defined in claim 15, further comprising displaying the popular media for the subset of users.

18. The method defined in claim 1, further comprising displaying information on popularity level of a recorded media.

19. The method defined in claim 18, wherein the popularity level comprises total number of users of the media, users of the media as a percentage of the total number of people in the subset of users, total number of accesses to the media, or total amount of time users spend on the media.

20. The method defined in claim 1, further comprising displaying in an interactive media guidance application an option to record the popular media.

21. The method defined in claim 20, wherein the interactive media guidance application is implemented on a user's equipment comprising the storage device, a processor, memory, and a user interface control device.

22. A system for recording popular media in an interactive media delivery system, comprising:
control circuitry and a storage device, the control circuitry configured to:
determine media that meets a minimum popularity threshold among at least a subset of users of the interactive media delivery system and select such media for recording, wherein as different media meets the threshold the different media is selected; and
direct the storage device to record at least a portion of the selected popular media.

23. The system defined in claim 22 wherein the control circuitry is further configured to select for recording the most popular media if more than one media meet the threshold at a given time.

24. The system defined in claim 22 wherein the popularity threshold comprises a number indicating a percentage of users in the interactive media delivery system that is watching or using media for the media to be selected for recording.

25. The system defined in claim 22 wherein the popularity threshold comprises a number indicating a percentage of users in the interactive media delivery system that is recording or have scheduled to record media for the media to be selected for recording.

26. The system defined in claim 22 wherein the control circuitry is at a server remote from a user's equipment, the control circuitry further configured to:
receive from equipment of the subset of users data indicative of the users' media selections;
process the data to generate identifier data indicative of the popular media; and
transmit the identifier data to said user's equipment.

27. The system defined in claim 26, wherein the user's equipment commences recording upon receipt of the identifier data from the server.

28. The system defined in claim 22 wherein the control circuitry is further configured to:
receive from a remote server popularity information; and
process the popularity information to generate identifier data indicative of the popular media.

29. The system defined in claim 22 wherein the control circuitry is further configured to exclude from selection for recording the popular media that are inconsistent with user preferences.

30. The system defined in claim 22 wherein the media is a television program, a video-on-demand (VOD) video, an Internet-delivered video, or digitally transmitted music.

31. The system defined in claim 22 wherein the storage device is within a user's equipment.

32. The system defined in claim 22 wherein the storage device is within a server remote from a user's equipment.

33. The system defined in claim 22 wherein the control circuitry is further configured to:
dedicate space on the storage device to record the selected popular media; and
direct the storage device to write over earlier-recorded media when the dedicated space has been filled.

34. The system defined in claim 22 wherein the control circuitry is further configured to tune to an analog channel or decode a digital signal.

35. The system defined in claim 22 wherein the control circuitry is further configured to:
determine the popular media among a subset of users within the interactive media delivery system that meets the threshold;
select the popular media among the subset of users; and
direct the storage device to record the selected popular media for the subset of users.

36. The system defined in claim 22 wherein the subset of users is defined according to user demographic, by zip code, geographical area, similar channel line-ups, city, county or state.

37. The system defined in claim 36, further comprising a display device, wherein the control circuitry is further configured to direct the display device to display demographic or neighborhood information on the subset of users.

38. The system defined in claim 36, further comprising a display device, wherein the control circuitry is further configured to direct the display device to display the popular media for the subset of users.

39. The system defined in claim 22, further comprising a display device, wherein the control circuitry is further configured to direct the display device to display information on popularity level of a recorded media.

40. The system defined in claim 39, wherein the popularity level comprises total number of users of the media, users of the media as a percentage of the total number of people in the subset of users, total number of accesses to the media, or total amount of time users spend on the media.

41. The system defined in claim 22, further comprising a display device, wherein the control circuitry is further configured to direct the display device to display in an interactive media guidance application an option to record the popular media.

42. The system defined in claim 41, wherein the interactive media guidance application is implemented on a user's equipment comprising the storage device, a processor, memory, and a user interface control device.

43-63. (canceled)
